(19) United States
(12) Patent Application Publication
(10) Pub. No.: US 2009/0241017 A1
(43) Pub. Date: Sep. 24, 2009

(54) SHARING SYNDICATED FEED BOOKMARKS AMONG MEMBERS OF A SOCIAL NETWORK

(75) Inventors: David A. Brooks, Providence, RI (US); Frank L. Jania, Chapel Hill, NC (US); Marty T. Moore, New York, NY (US)

Correspondence Address: Cuenot, Forsythe & Kim, LLC, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 12/053,556

(22) Filed: Mar. 22, 2008

(51) Int. Cl. G06F 17/00

(52) U.S. Cl. 715/206

(57) ABSTRACT

A computer-implemented method of bookmarking syndicated feeds. The method can include receiving a request to bookmark a first network resource and determining whether at least one syndicated feed is associated with the first network resource. When at least one syndicated feed is associated with the first network resource, the syndicated feed can be identified to a user and the user can be prompted to indicate whether to bookmark the syndicated feed. Responsive to receiving an indication from the user to bookmark the syndicated feed, a bookmark can be generated for the syndicated feed and the syndicated feed bookmark can be output.

### FIELD OF THE INVENTION

The embodiments of the present invention relate to network communications and, more particularly, to bookmarking of network resources.

### BACKGROUND OF THE INVENTION

Feed readers aggregate syndicated web content such as news headlines, web logs (blogs), podcasts and video blogs (vblogs) in a single location for easy viewing, thus creating a unique information space akin to a personal newspaper. A plethora of feed reading systems are currently available. Some feed readers are implemented as web based applications available to users via web portals, often referred to as feed aggregators, while other feed readers are client based. Client based feed readers are commonly implemented as plug-ins for Internet browsers or as stand-alone applications executed on computers or other devices having access to the Internet. In some instances, feed readers may even be setup in devices exclusively dedicated to receiving and displaying syndicated web content.

Feed readers reduce the time and effort needed to regularly check websites for content updates. Once a user has subscribed to one or more content feeds, at determined intervals a feed reader is able to automatically check for and retrieve new content that becomes available. For example, if a particular radio program is available for podcast every day at a regularly scheduled time, the feed reader can be configured to initiate download of the radio program at that time, or later if desired. The feed reader then can add corresponding program information to a content menu that is presented to the user and from which the user may access the content when desired. A user of a feed reader typically can unsubscribe to a particular feed at any time by merely removing the feed from a subscription list.

### BRIEF SUMMARY OF THE INVENTION

The embodiments disclosed herein relate to sharing of syndicated feed bookmarks. One embodiment of the present invention can include a computer-implemented method of bookmarking syndicated feeds. The method can include receiving a request to bookmark a first network resource and determining whether at least one syndicated feed is associated with the first network resource. When at least one syndicated feed is associated with the first network resource, the syndicated feed can be identified to a user and the user can be prompted to indicate whether to bookmark the syndicated feed. Responsive to receiving an indication from the user to bookmark the syndicated feed, a bookmark can be generated for the syndicated feed and the syndicated feed bookmark can be output.

Another embodiment of the present invention can include a method of sharing bookmarks for syndicated feeds. The method can include receiving from each of a plurality of clients at least one syndicated feed bookmark, identifying the syndicated feed bookmarks that are shared bookmarks, and communicating at least a selected portion of the shared bookmarks to at least one of the clients.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 is a block diagram illustrating a system for shared bookmarking of syndicated feeds in accordance with one embodiment of the present invention.

FIGS. 2-6 depict views of a user interface in accordance with various embodiments of the present invention.

FIG. 7 is a flowchart illustrating a method of sharing bookmarks for syndicated feeds in accordance with one embodiment of the present invention.

FIG. 8 is a flowchart illustrating a method of updating syndicated feed bookmarks in accordance with one embodiment of the present invention.

FIG. 9 is a flowchart illustrating a method of sharing bookmarks for syndicated feeds in accordance with another embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit,” “module,” or “system.”

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, a magneto-optical disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

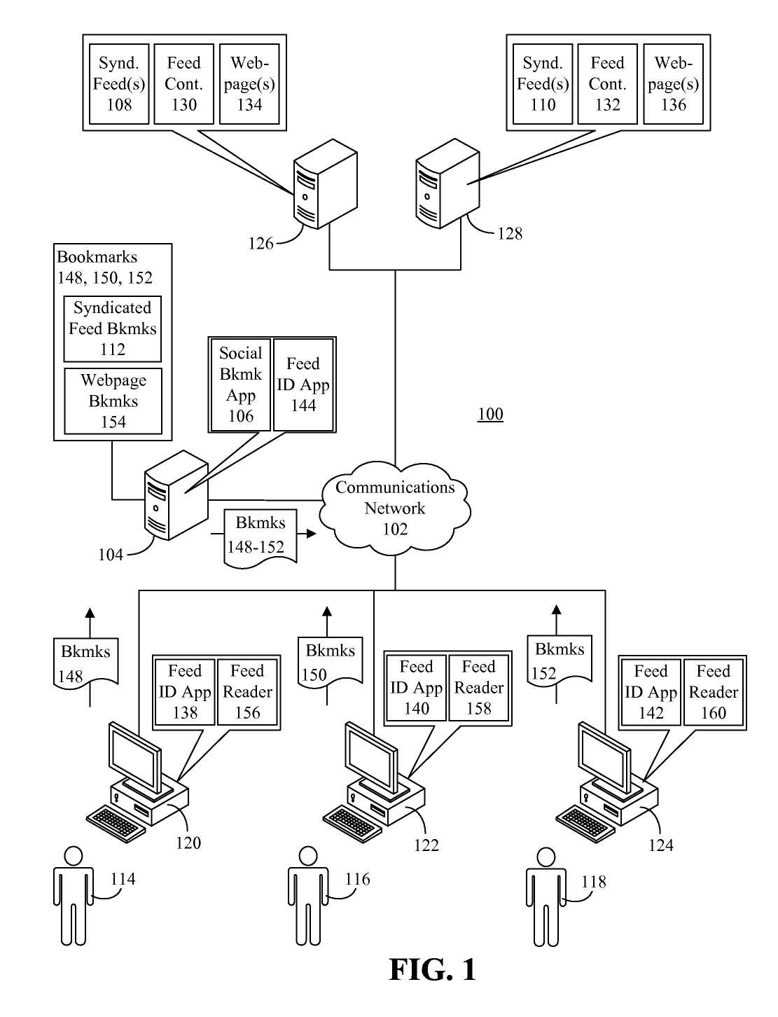

FIG. 1 is a block diagram illustrating a system 100 for bookmarking syndicated feeds in accordance with one embodiment of the present invention. The system 100 can include a communications network 102, which can be implemented as, or include, without limitation, a WAN, a LAN, the Public Switched Telephone Network (PSTN), the Web, the Internet, and one or more intranets. The communications network 102 further can be implemented as or include one or more wireless networks, whether short or long range. For example, in terms of short range wireless networks, the communications network 102 can include a local wireless network built using a Bluetooth or one of the IEEE 802 wireless communication protocols, e.g., 802.11a/b/g/i, 802.15, 802.16, 802.20, Wi-Fi Protected Access (WPA), or WPA2. In terms of long range wireless networks, the communications network 102 can include a mobile, cellular, and or satellite-based wireless network and support voice, video, text, and/or any combination thereof, e.g., GSM, TDMA, CDMA, and/or WCDMA network.

The system 100 can include a server 104, which can comprise a data processing system on which a social bookmarking application 106 may be instantiated. In addition to webpage bookmarks, the social bookmarking application 106 can maintain syndicated feed bookmarks 112 corresponding to syndicated feeds 108, 110, and share the syndicated feed bookmarks 112 among users 114, 116, 118, as will be described. As used herein, a bookmark is a saved link to a network resource that has been added to a list of saved links. As used herein, a syndicated feed is a document which comprises a structured version, meant to be readable by a machine, of one or more feed content items. Entries can sometimes be provided in a syndicated feed to provide links to full versions of feed content items, in which case the structured versions of the feed content items need not provide the entire feed content. For instance, the structured versions may comprise titles or short descriptions of the feed content. Further, the structured versions of the feed content items may exclude styling information associated with the feed content items.

In this context, a document is a bounded physical representation of a body of information designed with the capacity to communicate. In example, a syndicated feed can be implemented as an Extensible Markup Language (XML) document in accordance with the Really Simple Syndication (RSS) format or the Atom Syndication Format (Atom), although the invention is not limited in this regard and any other suitable document formats can be used. Examples of feed content can include, but are not limited to, audio content, video content, audio/video content, text (e.g. a newsfeed or blog), or the like.

In one embodiment, the users 114-118 can be members of a social network. As used herein, a “social network” is a social structure comprising nodes, which may be individuals or organizations, that are associated to one another by one or more specific interdependencies. Examples of such interdependencies can include, but are not limited to, place of employment, occupation, department association, division association, geographic location, hobby, education status, educational institution, college major, religion, and so on.

The system 100 can comprise a plurality of clients 120, 122, 124 with which the users 114-118 access system resources, for instance web servers 126, 128 on which the syndicated feeds 108, 110, feed content 130, 132 and/or webpages 134, 136 are hosted. Each of the clients 120-124 may comprise a data processing system and a user interface. For example, the clients 120-124 can be computers, mobile stations (e.g. mobile computers, personal digital assistants, mobile telephones, or the like), set-top boxes, internet appliances, or any other data processing systems which may be used to browse a network, such as the Internet, and access the webpages 134, 136. The clients 120-124 can be communicatively linked to the server 104 and the web servers 126, 128 via the communications network 102 or in another suitable manner.

In one embodiment, a feed identification and bookmark application (hereinafter “feed ID application”) 138, 140, 142 can be instantiated on each of the respective clients 120-124. In another embodiment, a feed ID application 144 can be instantiated on the server 104 or included as a component of the social bookmark application 106 that is instantiated on the server 104. In the latter embodiment, the clients 120-124 can initiate client sessions with the server 104 when browsing resources of the system 100, and the feed ID application 144 can track network content accessed by the clients 120-124. For example, when the client 120 communicates messages to the web servers 126, 128, the client 120 also can communicate corresponding messages to the feed ID application 144. The feed ID application 144 then can access the same information being accessed by the client 120.

Regardless of whether the feed ID application(s) 138-142 are instantiated on the clients 120-124 or the feed ID application 144 is instantiated on the server, the instantiated feed ID application(s) can examine information on the web servers 126, 128 accessed by the respective clients 120-124 to determine whether syndicated feeds 108, 110 are available, provide an indication of such determination to the respective users 114-118, and interface with the social bookmark application 106, as will be described herein. For the purpose of clarity, the examples hereinafter will be described in the context of the feed ID applications 138-142 being instantiated on the respective clients 120-124 but, as noted, in an alternative embodiment the feed ID application 144 can be instantiated on the server 104, and thus the invention is not limited in this regard.

In example, while the user 114 is browsing the webpages 134 provided by the web server 126, the feed ID application 138 can scan the content of the webpages 134 to identify any syndicated feeds 108 associated with the webpages 134. For instance, the feed ID application 138 can identify links, tags, metadata or other identifiers provided with the webpages 134 that correspond to the syndicated feeds 108.

If the feed ID application 138 receives a user input to bookmark a network resource (e.g. the webpage 134) that is associated with one or more of the syndicated feeds 108, the feed ID application 138 can present a message to inform the user 114 that such syndicated feeds 108 are available. The feed ID application 138 also can prompt the user 114 to indicate whether to bookmark one or more of the syndicated feeds 108 and whether to continue bookmarking the network resource. The user 114 then can select to bookmark the network resource and the syndicated feed(s) 108, to exclusively bookmark the network resource, to exclusively bookmark one or more syndicated feed 108, or to cancel the bookmark request. Unless the bookmark request is canceled, the feed ID application 138 can process the user selections to generate corresponding bookmark(s) 148. In an embodiment in which the feed ID application 144 instantiated on the server 104 is used in lieu of the feed ID application 138, messages to be presented to the user 114 and user responses can be communicated between the feed ID application 144 and the client 120 via the communications network 102.

In response to the user 114 selecting to bookmark the syndicated feed(s) 108 and/or the network resource, the feed ID application 138 can identify a uniform resource identifier (URI) (e.g. a uniform resource locator (URL) or a uniform resource name (URN)) associated with the resource being bookmarked and include the URI in the bookmark 148. The feed ID application 138 also can retrieve from the web server 126 information pertaining to the syndicated feed(s) 108 and corresponding feed content 130. For instance, the feed ID application 138 can retrieve a title, one or more tags, a short description, a long description, and/or the like. Such information can be contained within the syndicated feed 108 or the feed content 130, or otherwise associated with the syndicated feed 108 in a suitable manner. The retrieved information then can be associated with the bookmark(s) 148. For instance, the feed ID application 138 can include the information within the bookmark(s) 148.

The feed ID application 138 also can prompt the user 114 to associate one or more identifiers, comments, tags or other information to indicate the nature of the syndicated feed content 130, and to indicate whether the bookmark 148 generated for the syndicated feed 108 is to be a private bookmark or a shared bookmark. In one embodiment, the user entered information can provide one or more identifiers that categorizes the bookmark 148 into a particular bookmark class or type, or assigns the bookmark to a particular social group. For example, if the feed content is tutorial in nature, the bookmark can be categorized as “tutorial”. The feed ID application 138 can include within the bookmark 148 the information entered by the user 114 and, optionally, a user identifier corresponding to the user 114.

The feed ID application 138 then can output the bookmark 148. For instance, the feed ID application 138 can communicate the bookmark 148 to the social bookmark application 106. The bookmark 148 can be communicated using outline processor markup language (OPML) or in any other suitable manner. The bookmark 148 can be communicated when it is established, at a particular time, in response to an event (e.g. a user input, launching or closing of an application, etc.), or communicated at any other suitable time. In one embodiment, bookmarks 148 selected by the user 114 can be maintained on the client 120, and a plurality of such bookmarks 148 communicated to the social bookmark application 106 at scheduled intervals. The feed ID applications 140, 142 also can generate respective bookmarks 150, 152 in a manner synonymous with that described above and forward such bookmarks 150, 152 to the social bookmark application 106.

The social bookmark application 106 can store the bookmarks 148-152 in a suitable manner. For example, the bookmarks 148-152 can be stored in one or more data tables, data files, text files, or in any other suitable format. Moreover, the bookmarks 148-152 can be stored on the server 104 or on another apparatus comprising a computer usable medium that is made accessible to the social bookmarking application 106. The bookmarks 148-152 can comprise syndicated feed bookmarks 112, webpage bookmarks 154 and/or bookmarks corresponding to any other system resources.

The bookmarks 148-152 indicated as being shared bookmarks can be identified and shared among the users 114-118, as well as other users who share social network affiliations with the users 114-118. For example, the social bookmark application 106 can communicate the shared bookmarks 148-152 to the clients 120-124 for use with corresponding feed readers 156, 158, 160 instantiated on the clients 120-124. In another embodiment, the shared bookmarks 148-152 can be made available to the users via a feed aggregator which hosts client feed reading sessions via the communications network 102. Such feed aggregator can be hosted on the server 104 or elsewhere in the system 100. The shared bookmarks 148-152 can be communicated using outline processor markup language (OPML) or in any other suitable manner.

The shared bookmarks 148-152 provided to a particular user, for instance the user 116, can be limited to a portion of the total bookmarks 148-152 stored by the server. For example, the user 116 can be provided a prompt to select one or more types of bookmarks, one or more classes of bookmarks, bookmarks associated with one or more particular users or social groups, bookmarks having certain identifiers, tags, titles, dates or rankings, and so on. In addition, the user 116 can subscribe to receive updates to the selected group of shared bookmarks 148-152. For instance, if the user 116 subscribes to a certain class of bookmarks 148-152, the user's feed reader 158 or feed aggregator can be updated with new bookmarks 148-150 that are assigned to that class. Such updates can occur as the new bookmarks 148-150 are received by the social bookmarking application 106, at a scheduled interval, in response to a request generated by the user 116, or in response to a request generated by the user's feed reader 158 or feed aggregator.

The user 116 also can supplement the selection of bookmarks 148-152 with additional bookmarks, for instance those generated by the user 116 (e.g. via the feed ID application 140). Such bookmarks can be shared, but this need not be the case. Further, shared bookmarks 150 generated by the user 116/feed identification application 140 need not be contained in the bookmark 148-152 updates if they have already been added to the user's feed reader 158 or feed aggregator, though this is not a requirement.

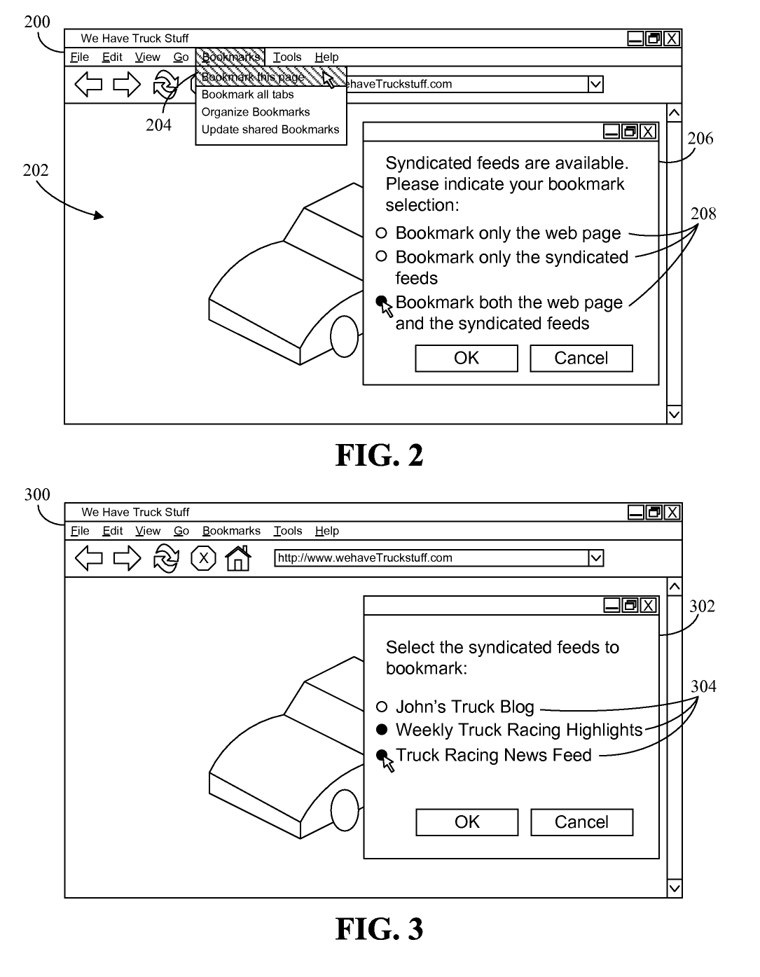

FIG. 2 is a view 200 of a user interface in accordance with one embodiment of the present invention. The feed ID application can present the view 200 via a user interface of a client. During operation, a user browsing a webpage 202 can select to bookmark the webpage 202. The selection can be made by selecting a menu item 204, entering a particular key stroke or sequence of key strokes, uttering a term or phrase, or in any other suitable manner. In response, the user can be prompted to select whether to bookmark only the webpage, bookmark only syndicated feeds associated with the webpage, or bookmark both the webpage and syndicated feeds. For example a menu 206 of selectable options 208 can be presented to the user.

Referring to FIG. 3, which is another view 300 of the user interface, in response to the user selecting to bookmark only the syndicated feeds or bookmark both the webpage and syndicated feeds, the user can be prompted to select which associated syndicated feeds to bookmark. For instance, a menu 302 of selectable options 304 from which syndicated feeds can be selected can be presented to the user.

Referring to FIG. 4, which is another view 400 of the user interface, in response to the user selecting one or more syndicated feeds to bookmark, the user can be prompted to indicate whether to share the bookmark for the selected syndicated feed(s). For instance, a menu 402 can be presented for each of the selected syndicated feeds. The menu 402 can present both “Don't share” and “Share” options 404 from which the user may select. If the user selects to share the bookmark, the user can be prompted to input one or more indicators pertaining to the subject syndicated feed. For instance a text input field 406 can be presented in the menu 402. An indicator can comprise, a tag, a title, a description, a comment, or any other information that may be associated with the syndicated feed to indicate the nature of the syndicated feed.

An input field 408 also can be presented in the menu 402 to receive a user selection to assign the bookmark to one or more groups, types and/or classes. Alternatively, such assignment can be implemented automatically with the user being given an option to override such assignment. For example, the subject bookmark can be automatically assigned a social group who's bookmarks are currently being presented in the user's feed reader or feed aggregator. Data representing the user's selection of whether to share the bookmark and representing the bookmark indicators and assignments can be associated with the bookmark. For instance, such data can be included within the bookmark or within an associated file.

FIG. 5 is a view 500 of a user interface in accordance with another embodiment of the present invention. A feed reader or feed aggregator can present the view 500 to a user via a user interface of a client. During operation the user can interface with the feed reader (or feed aggregator) to select to update bookmarks presented in the feed reader (or feed aggregator). Such selection can be made in lieu of, or in addition to, any other bookmark update processes (e.g. scheduled updates, etc.). The selection can be made by selecting a menu item 502, entering a particular key stroke or sequence of key strokes, uttering a term or phrase, or in any other suitable manner. In response, the user can be prompted to select whether to update all bookmarks to which the user has access, or only selected bookmarks. For example a menu 504 with selectable options 506 can be presented to the user.

Further, the user can be prompted to enter bookmark selection criteria. For instance, the user can be presented input fields 508 in which to specify one or more groups, members, tags or rankings. Any other parameters which can be used as bookmark selection criteria also can be specified, for example bookmark classes, dates when marked, and so on. The selection criteria can be communicated as a request to the social bookmark application, which can select bookmarks that match the criteria. Such bookmarks can include syndicated feed bookmarks, webpage bookmarks, and any other bookmarks that match the criteria. The selected bookmarks then can be communicated to the user's feed reader or feed aggregator, which can present the bookmarks to the user to provide links to the bookmarked resources.

Referring to FIG. 6, which is another view 600 of the user interface, an example of updated bookmarks is depicted. Notably, in addition to a webpage bookmark 602, bookmarks 604, 606, 608 for syndicated feeds can be presented. A variety of information about the bookmarks also can be presented, for example, tags associated with the bookmarks, who generated the bookmarks, when the bookmarks were generated, and so on.

At this point it should be noted that FIGS. 2-6 are merely examples depicted to facilitate understanding of the present invention, and the invention is not limited to these examples. For instance, other schemes may include text-to-speech synthesis for presenting information to users and speech recognition for receiving spoken utterances as user inputs. Still, one skilled in the art will appreciate that user suitable interfaces can utilize any of a myriad of schemes to present information to users and to receive user inputs, and any such schemes are within the scope of the present invention.

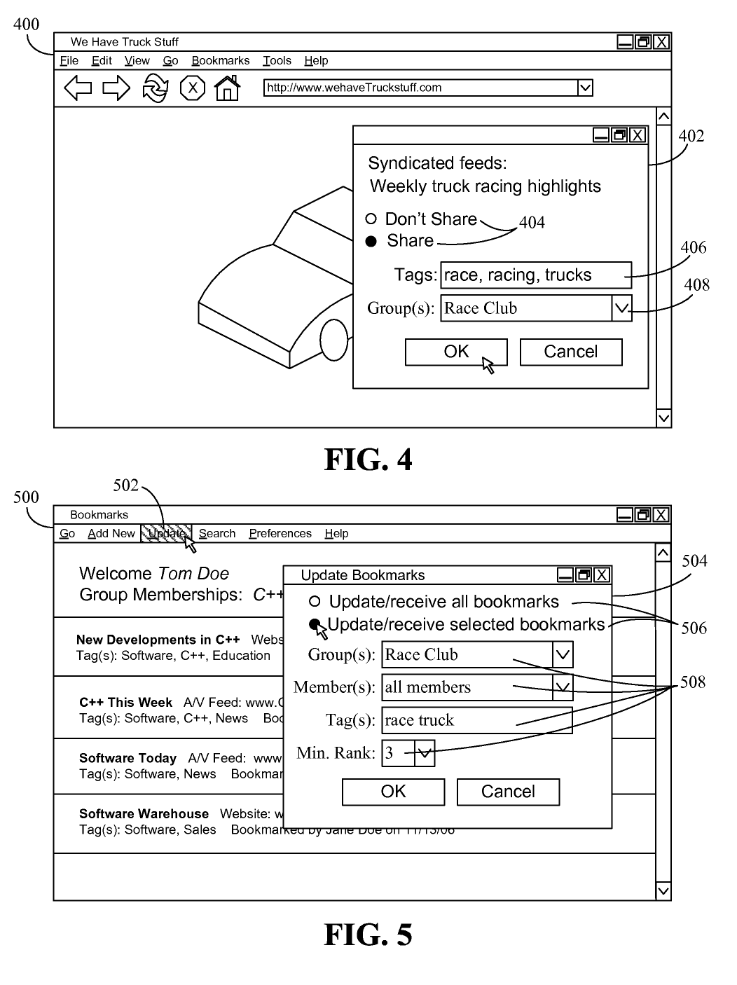

FIG. 7 is a flowchart illustrating a method 700 sharing bookmarks for syndicated feeds in accordance with another embodiment of the present invention. The method 700 can be implemented using a feed identification application, such as that described herein, or with other suitable software. At step 702, a request to bookmark a first network resource can be received. At step 704, a determination can be made whether at least one syndicated feed is associated with the first network resource. Any such syndicated feeds can be indicated to a user. At step 706 the user can be prompted to indicate whether to bookmark the first network resource. In addition, the user can be prompted to indicate whether to bookmark one or more syndicated feeds that may have been identified. The user also can be prompted to indicate whether to share any of the bookmarks.

At step 708 the user can be prompted to provide for each syndicated feed bookmark to be shared at least one indicator that indicates the nature of the syndicated feed. At step 710 the indicators can be associated with the syndicated feeds. At step 712 the syndicated feed bookmarks can be output. As used herein, “output” or “outputting” can include, but is not limited to, storing data in memory, e.g., writing to a file, writing to a user display or other output device, e.g., playing audible notifications, sending or transmitting to another system, exporting, or the like. For instance, the indicated feeds can be communicated to certain feed readers and/or feed aggregators.

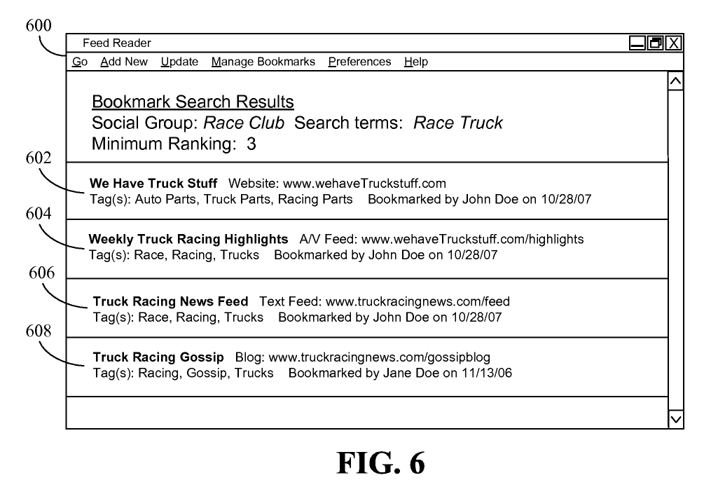

FIG. 8 is a flowchart illustrating a method 800 of sharing bookmarks for syndicated feeds in accordance with another embodiment of the present invention. The method 800 can be implemented using a social bookmark application, such as that described herein, or with other suitable software. At step 802, at least one syndicated feed bookmark can be received from each of a plurality of clients. At step 804 syndicated feed bookmarks that are shared bookmarks can be identified. At step 806 a selected portion of the shared bookmarks can be communicated to at least one of the clients.

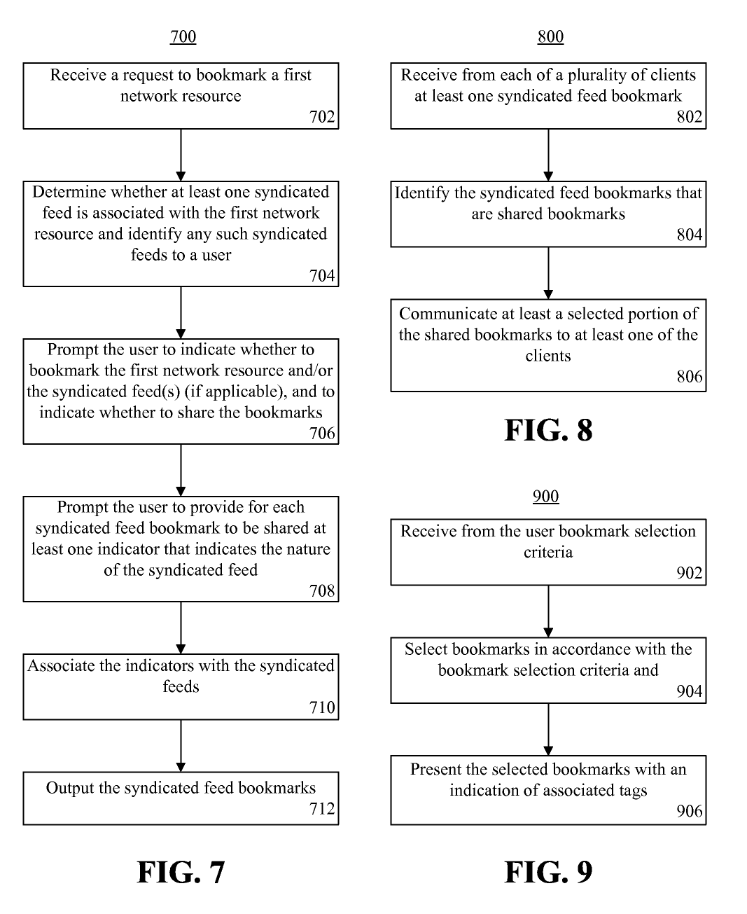

FIG. 9 is a flowchart illustrating a method 900 of updating syndicated feed bookmarks in accordance with another embodiment of the present invention. The method 700 can be implemented using a feed identification application, such as that described herein, or with other suitable software. At step 902 user bookmark selection criteria can be received. At step 904 bookmarks can be selected in accordance with the bookmark selection criteria. At step 906 the selected bookmarks can be presented. For instance, the bookmarks can be presented with an indication of tags that have been associated with the bookmarks.

The flowchart(s) and block diagram(s) in the figures illustrate the architecture, functionality, and operation of possible implementations of systems, methods and computer program products according to various embodiments of the present invention. In this regard, each block in the flowchart(s) or block diagram(s) may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram(s) and/or flowchart illustration(s), and combinations of blocks in the block diagram(s) and/or flowchart illustration(s), can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A computer-implemented method of bookmarking syndicated feeds, the method comprising:
receiving a request to bookmark a first network resource;
determining whether at least one syndicated feed is associated with the first network resource;
when at least one syndicated feed is associated with the first network resource:
identifying the syndicated feed to a user; and
prompting the user to indicate whether to bookmark the syndicated feed;
responsive to receiving an indication from the user to bookmark the syndicated feed, generating a bookmark for the syndicated feed; and
outputting the syndicated feed bookmark.

2. The method of claim 1, further comprising:
prompting the user to indicate whether to bookmark the first network resource; and
bookmarking the first network resource in response to receiving an indication to bookmark the first network resource.

3. The method of claim 1, further comprising:
receiving from the user an indication of whether to share the bookmark; and
associating the indication with the bookmark.

4. The method of claim 1, further comprising:
receiving from the user at least one indicator pertaining to the syndicated feed that indicates the nature of the syndicated feed; and
associating the indicator with the bookmark.

5. The method of claim 1, wherein outputting the bookmark comprises communicating the bookmark to a social bookmark application to be shared with at least a second user.

6. The method of claim 1, further comprising:
updating shared bookmarks presented to the user in a feed reader or a feed aggregator.

7. The method of claim 6, further comprising:
receiving from the user bookmark selection criteria;
wherein updating the shared bookmarks comprises selecting bookmarks to present to the user in accordance with the bookmark selection criteria.

8. The method of claim 7, further comprising:
presenting the selected bookmarks to the user with an indication of tags associated with the selected bookmarks

9. A computer-implemented method of sharing bookmarks for syndicated feeds, the method comprising:
receiving from each of a plurality of clients at least one syndicated feed bookmark;
identifying the syndicated feed bookmarks that are shared bookmarks; and
communicating at least a selected portion of the shared bookmarks to at least one of the clients.

10. The method of claim 9, wherein receiving the syndicated feed bookmarks comprises receiving an indication of whether the bookmarks are shared bookmarks.

11. The method of claim 9, wherein receiving the syndicated feed bookmarks comprises receiving at least one indicator pertaining to the syndicated feed that indicates the nature of the syndicated feed.

12. The method of claim 9, wherein receiving the bookmarks for syndicated feeds comprises receiving at least one identifier that indicates who bookmarked the syndicated feed.

13. A computer program product comprising:
a computer-usable medium comprising computer-usable program code that bookmarks syndicated feeds, the computer-usable medium comprising:
computer-usable program code that receives a request to bookmark a first network resource;
computer-usable program code that determines whether at least one syndicated feed is associated with the first network resource;
computer-usable program code that, when at least one syndicated feed is associated with the first network resource, identifies the syndicated feed to a user and prompts the user to indicate whether to bookmark the syndicated feed;
computer-usable program code that generates a bookmark for the syndicated feed in response to receiving an indication from the user to bookmark the syndicated feed; and
computer-usable program code that outputs the syndicated feed bookmark.

14. The computer program product of claim 13, further comprising:
computer-usable program code that prompts the user to indicate whether to bookmark the first network resource; and
computer-usable program code that bookmarks the first network resource in response to receiving an indication to bookmark the first network resource.

15. The computer program product of claim 13, further comprising:
computer-usable program code that receives from the user an indication of whether to share the bookmark; and
computer-usable program code that associates the indication with the bookmark.

16. The computer program product of claim 13, further comprising:
computer-usable program code that receives from the user at least one indicator pertaining to the syndicated feed that indicates the nature of the syndicated feed; and
computer-usable program code that associates the indicator with the bookmark.

17. The computer program product of claim 13, wherein computer-usable program code that outputs the bookmark comprises computer-usable program code that communicates the bookmark to a social bookmark application to be shared with at least a second user.

18. The computer program product of claim 13, further comprising:
computer-usable program code that updates shared bookmarks presented to the user in a feed reader or a feed aggregator.

19. The computer program product of claim 18, further comprising:
computer-usable program code that receives from the user bookmark selection criteria;
wherein computer-usable program code that updates the shared bookmarks comprises computer-usable program code that selects bookmarks to present to the user in accordance with the bookmark selection criteria.

20. The computer program product of claim 19, further comprising:
computer-usable program code that presents the selected bookmarks to the user with an indication of tags associated with the selected bookmarks.
